(19) United States
(12) Patent Application Publication
(10) Pub. No.: US 2024/0346922 A1
(43) Pub. Date: Oct. 17, 2024

(54) Method for Evaluating a Traffic Scene with Several Road Users

(71) Applicant: Robert Bosch GmbH, Stuttgart (DE)

(72) Inventors: Benjamin Coors, Stuttgart (DE); Felix Schmitt, Ludwigsburg (DE); Johannes Goth, Wildberg (DE); Maximilian Naumann, Merzig (DE); Reinis Cimurs, Stuttgart (DE)

(21) Appl. No.: 18/631,899

(22) Filed: Apr. 10, 2024

(30) Foreign Application Priority Data
Apr. 11, 2023 (DE) 10 2023 203 275.9

(51) Int. Cl. G08G 1/01; B60W 60/00; G08G 1/123

(52) U.S. Cl. CPC G08G 1/0141; B60W 60/00276; G08G 1/0129; G08G 1/123

(57) ABSTRACT

A method for evaluating a traffic scene with several road users includes (i) providing input data which results from recording of the traffic scene and which specifies the road users and associated features, the features being based at least in part on current and past states of the road users, (ii) providing a representation of the road users and their relationships to each other in the traffic scene and an infrastructure of the traffic scene, wherein the relationships are specified based on the features, wherein the infrastructure is represented by a parameterized representation, wherein the representation comprises a plurality of nodes of a graph representing the respective road users, and wherein the representation comprises a plurality of edges of the graph explicitly specifying the relationships of the road users to each other, (iii) predicting a future development of the traffic scene, wherein the prediction is performed taking into account the current and past states of the road users, wherein a behavior of all represented road users is predicted on the basis of the provided representation, and (iv) providing a result of the prediction.

This application claims priority under 35 U.S.C. § 119 to patent application no. DE 10 2023 203 275.9, filed on Apr. 11, 2023 in Germany, the disclosure of which is incorporated herein by reference in its entirety.

The disclosure relates to a method for evaluating a traffic scene with several road users. The disclosure also relates to a computer program, a device, a training method and a storage medium for this purpose.

### BACKGROUND

Conventional methods that focus on driver modeling or prediction by differentiable simulation often use rendered grids (with map and agents) as discrete input or rendered grids with rotated focus area (region of interest). Such solutions are described, for example, in Scibior et al., “Imagining The Road Ahead: Multi-Agent Trajectory Prediction via Differentiable Simulation”, arXiv: 2104.11212v1 or in Suo et al., “TrafficSim: Learning to Simulate Realistic Multi-Agent Behaviors”, CVPR2021, arXiv: 2101.06557v1.

A method without differentiable simulation has been published e.g., in Gao et al., “VectorNet: Encoding HD Maps and Agent Dynamics from Vectorized Representation”, arXiv: 2005.04259v1.

### SUMMARY

The subject of the disclosure is a method, a computer program, a training method, a device, and a computer-readable storage medium having the features set forth below. Further features and details of the disclosure will emerge from the description and the drawings. Features and details described in connection with the method according to the disclosure naturally also apply in connection with the computer program according to the disclosure, the training method according to the disclosure, the device according to the disclosure and the computer-readable storage medium according to the disclosure, and vice versa in each case, so that reference is or can always be made to the individual aspects of the disclosure with respect to the disclosure.

The subject matter of the disclosure is in particular a method for evaluating a traffic scene with a plurality of road users. The method can comprise the provision of input data, for example in the form of digital data such as a video recording, which can result from recording the traffic scene. For example, cameras that record the surroundings of a vehicle and make them available as input data can be used to record the traffic scene. Thus, the input data can specify the road users and associated features, wherein the features can be based at least in part on-preferably differentiable-current and past states of the road users. In particular, this means that the input data specifies the states of the road users for a current but also at least one or more past driving situation(s). The states can specify differentiable states such as the speed or acceleration of road users. This makes it possible to (mathematically) differentiate the state progression based on the input data.

Furthermore, the method according to the disclosure can comprise providing a representation of the road users and/or their relationships to one another in the traffic scene and/or an infrastructure of the traffic scene. The relationships can be specified on the basis of the features, e.g., by specifying a relative speed or similar.

The infrastructure can be represented by a parameterized representation. In particular, this means that the infrastructure, such as a roadway, is not represented on a grid basis, i.e., not by grid cells, for example, but by parameters such as a polyline or similar, e.g., using scalar values. This enables continuous representation of the infrastructure. This can significantly improve the accuracy and training of the prediction.

Furthermore, the representation can have several nodes of a graph, which represent the respective road users. In addition, the representation can have several edges of the graph which specify the relationships of the road users to each other, preferably explicitly to each other. This can be made possible in particular by using a graph neural network (GNN for short) as a machine learning model. The relationships can be specified explicitly in particular by using relative features such as distance, differential speed and the like (especially in the input data or as input for the model). In other words, it may be intended that these relationships are explicitly specified and not (only) learned by the machine learning model, especially network, itself, for example by simply using the respective absolute features as input for the model (such as position, speed, . . .).

Furthermore, the method can comprise predicting a future development of the traffic scene, in particular on the basis of the representation provided. The prediction can be carried out taking into account the current and/or past states of the road users. In addition, the behavior of all represented road users can be predicted on the basis of the representation provided, in particular on the basis of a single representation, especially a GNN. This has the advantage that only a single representation, preferably a single graph, preferably a single GNN, is required to predict the behavior of several road users in the traffic scene. The result of the prediction can then be provided, e.g., in the form of a predicted trajectory for the movement of the respective road user. The method according to the disclosure has the advantage that an improved representation and thus an improved prediction of the traffic scene is possible. The road users are also referred to below as agents.

It may also be possible for the features to be semantic features which can be calculated, in particular constantly and/or in a differentiable manner, from the current and past states, the features preferably being invariant in terms of rotation and translation with respect to, in particular global, coordinates of the traffic scene. The features, in particular node features, can therefore be differentiable and/or semantic features. In particular, it is intended that the features are either constant, e.g., agent type or agent dimensions, or are calculated in a differentiable manner from a history of differentiable states, such as speed, acceleration, yaw rate or the like. In particular, the use of differentiable states enables differentiable training for prediction, which can reduce errors and inaccuracies in prediction. The global coordinates can preferably be coordinates of a global coordinate system, in particular a fixed coordinate system, i.e., fixed to the street of the traffic scene, for example.

Furthermore, the features in the input data can be specified from the perspective of the agents, i.e., “agent-relative”. This has the advantage that an improved representation and prediction of the behavior of road users is possible.

The input data can include coordinates in order to localize the road users, e.g., on a map. The input data and/or the representation can be invariant in terms of rotation and translation. This means that the behavior of the representation, in particular the machine learning model, remains the same even if the card and agent are rotated or moved.

The term “differential” can refer to the use of derivations, especially partial derivations. This allows the effects of small changes in the input variables on the output variables or the error of the model to be calculated. This technique is also known as differential learning and is used in various machine learning algorithms and techniques, especially in the optimization of neural networks and other models with gradient descent. Differential learning calculates the partial derivations of the loss function or other functions with respect to the input data to determine how much small changes in the input data affect the output of the model. The states can be differentiable, for example, if the underlying function is smooth or continuously differentiable. In this case, a machine learning method can be used on the basis of the differentiable states. Such states are, for example, the speed of the road user, but not, for example, the distance to the vehicle in front, because the vehicle in front can change, which leads to a jump in the said distance.

Furthermore, it is advantageous if, in the context of the disclosure, the prediction is carried out by means of a machine learning model, which is preferably implemented as a graph neural network. The machine learning model can have nodes and edges, with the nodes preferably representing the states of the respective road users. The machine learning model can also be referred to as a model for short and implemented, in particular, as an agent-centered graph neural network. A GNN is a type of artificial neural network that can be used to process data on graphs and other structured data. This makes it possible to model complex relationships between the nodes of the graph. A graph can have a number of nodes (also known as “vertices” or “nodes”) that are connected by edges (also known as “edges”). In this way, the edges can represent the relationships between the nodes. In the present disclosure, the nodes can represent the state of an agent. In addition, the nodes may comprise a combination of different embeddings, which are hereinafter referred to as a first embedding, a second embedding, etc. While the input data can comprise a certain number of features (e.g., 6), the embeddings can also have an embedding size, e.g., 64. Accordingly, an encoder would embed the features so that they can be processed further by the network. If, for example, the features specify differentiable states such as the speed of a road user, the first embedding can interpret these features and derive further states from them if necessary.

A further advantage can be achieved within the scope of the disclosure if a machine learning model is used to provide the representation, which comprises a first embedding which is at least partially based on the features and which comprises a second embedding which specifies a topology at the traffic scene, preferably the first and/or second embedding being invariant in terms of rotation and translation with respect to, in particular, global coordinates for the traffic scene. The first embedding can be a differentiable embedding based on semantic features that are either constant, such as agent type, agent dimensions or the like, or can be calculated in a differentiable way from a history of states, such as velocity, acceleration, yaw rate or the like. These features can be designed in such a way that they are invariant in terms of rotation and translation with respect to the coordinates, especially global coordinates. The second embedding can be a differentiable embedding of the topology and in particular of the infrastructure, which is preferably invariant in terms of rotation and translation with respect to the coordinates, in particular global coordinates.

In addition, the edges can represent the spatial and state-based relationship between two agents, in particular based on semantic features calculated in a differentiable manner from the state progressions of the agents, such as difference in position, difference in velocity, difference in acceleration, difference in heading or the like. These features can in turn be selected so that they are invariant in terms of rotation and translation in relation to the coordinates, especially global coordinates.

It may also be possible that a machine learning model is used to provide the representation, wherein the features are at least partially based on the (in particular differentiable) current and past states, and are preferably calculated in a differentiable manner from the state progressions of these states, and preferably a first and/or second embedding of the machine learning model is implemented in a differentiable manner in order to train the machine learning model by means of a differentiable simulation. The proposed solution can be invariant in terms of rotation and translation and thus utilize the existing knowledge of the driving task. As such, it can generalize new scenarios better and requires less training data compared to other approaches. Compared to conventional solutions that use, for example, complex group-theoretic operators for invariance, the invariant approach of the present disclosure is simpler and therefore faster and more resource-efficient. At the same time, the interactions between the agents can also be modeled explicitly, which enables better predictions than conventional approaches. In addition, the differentiable nature also enables training with differentiable simulation approaches. This enables an accurate prediction of long-term behavior, especially based on sequential decisions instead of a single prediction.

One use of differentiable simulation for training a model is described, for example, in “Scibior et al., Imagining The Road Ahead: Multi-Agent Trajectory Prediction via Differentiable Simulation, In: arXiv: 2104.11212v1 [stat.ML] 22 Apr. 2021” or in “Suo et al., TrafficSim: Learning to Simulate Realistic Multi-Agent Behaviors, CVPR2021, In: arXiv: 2101.06557v1 [cs.RO] 17 Jan. 2021”. For example, a traffic scene is modeled as a sequential process in which the road users interact and plan their behavior in each time step. With the help of a differentiable observation module and a common strategy (or “policy”) for road users, traffic scenes can be represented by simulating the movement of road users for several steps. Then a backpropagation by differentiable simulation can be used to calculate and optimize the loss at each simulation step. This is possible in particular because the state transitions are modeled in a completely differentiable manner. By passing messages over a fully connected graph, especially interaction graphs, with road users as nodes, the latent space can learn to record not only the destinations and style of individual road users, but also the interactions of multiple road users.

Optionally, it is conceivable that the prediction is carried out on the basis of machine learning, wherein a simulation is provided in the machine learning, in which the machine learning is carried out on the basis of a difference between the current and past states of the road users, wherein the simulation is preferably implemented as a differentiable simulation. In particular, it is also possible to train the model using gradient descent by simulating the forward movement of a particular road user, in which, for example, the old position of the road user and the difference estimated by the model are used as the new position. This is particularly possible if the features used are either constant (e.g., vehicle type) or can be mathematically calculated in a differentiable manner from the agent's status history.

In addition, the node and edge features can provide a compact, expressive and flexible representation. Compared to a gridded representation, where the vehicle positions are discretized in pixel coordinates, the node and edge features can model the information more explicitly and accurately since no discretization is required. In addition, the node and edge features, which can essentially be just an information vector, can be more flexible as they can easily be extended to include information that would be difficult to visualize in a gridded representation.

It is also conceivable that the behavior of an at least semi-autonomous robot and in particular a vehicle can be planned on the basis of the prediction result provided, wherein the robot can be part of the traffic scene and can be equipped with a vehicle's own sensor system, such as at least one camera, in order to record the input data. The disclosure can thus be used for analyzing data obtained from at least one sensor, for example in an at least semi-autonomous robot such as a vehicle or the like. The sensor can carry out measurements of its environment and provide the result of these measurements in the form of sensor signals, which can be provided by trajectory and map data, for example. For example, the sensor signal can be digitized in order to provide the input data in the form of digital data. The method according to the disclosure can be used, for example, to calculate a control signal for controlling the robot. This is done, for example, by learning a strategy for controlling the robot and then operating the robot accordingly. The disclosure can also be part of a machine learning training pipeline that uses imitation learning (cloning of behaviors) to train driver models.

Another object of the disclosure is a training method for training a machine learning model for evaluating a traffic scene with several road users. According to a first training step, a provision of training data can be provided, wherein the training data can specify road users in a traffic scene and associated features. The features can be based at least in part on, in particular differentiable, current and past states of road users. According to a second training step, the machine learning model can be trained to predict a future development of the traffic scene. The road users can be represented by nodes of a graph and their relationships in the traffic scene can be represented by edges of the graph. The relationships can also be specified on the basis of the features. It is also possible for an infrastructure of the traffic scene to be represented by a parameterized representation. The prediction can be trained by in particular a differentiable simulation, taking into account the current and past states of the road users in order to predict the behavior of all the road users represented on the basis of the representation provided. Thus, the training method according to the disclosure offers the same advantages as have been described in detail with reference to a method according to the disclosure. In addition, the machine learning model used in the method according to the disclosure may have been trained by the training method according to the disclosure.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

Furthermore, the method according to the disclosure and/or the training method according to the disclosure can also be implemented as a computer-implemented method.

### BRIEF DESCRIPTION OF THE DRAWINGS

Further advantages, features and details of the disclosure will emerge from the following description, in which exemplary embodiments of the disclosure are described in detail with reference to the drawings. The features mentioned in the claims and in the description can each be essential to the disclosure individually or in any combination. Here:

FIG. 1 a schematic visualization of a method, a device, a storage medium, a training method and a computer program according to exemplary embodiments of the disclosure.

FIG. 2 the model with further details according to exemplary embodiments of the disclosure.

### DETAILED DESCRIPTION

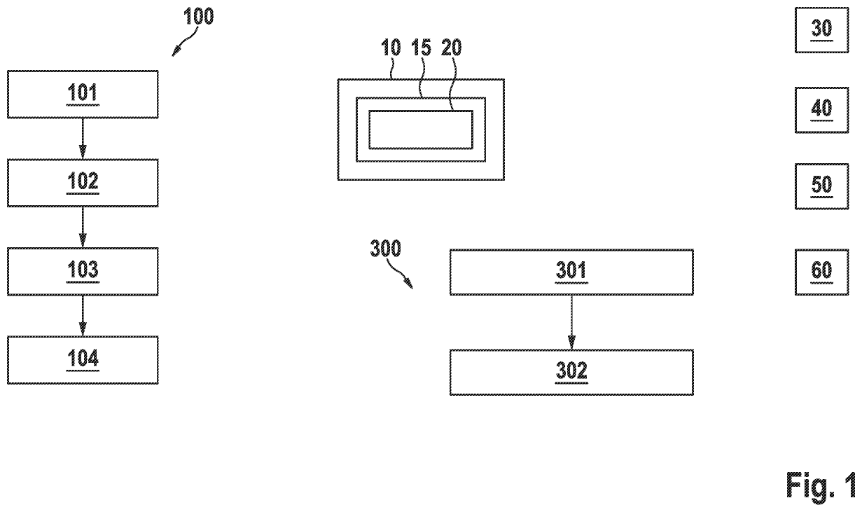

FIG. 1 schematically illustrates a method 100, a device 10, a storage medium 15, a training method 300 and a computer program 20 according to exemplary embodiments of the disclosure. To evaluate a traffic scene with several road users 30, the method 100 can have several method steps, which are preferably carried out one after the other and/or repeatedly. According to a first method step 101, input data 40 can be provided, which results from recording of the traffic scene and which specifies the road users 30 and associated features. The features can be based at least in part on, in particular differentiable, current and past states of the road users 30. According to a second method step 102, the road users 30 and their relationships to each other in the traffic scene as well as an infrastructure of the traffic scene can be represented by a representation. The relationships can be specified on the basis of the features, wherein the infrastructure can be represented by a parameterized representation. Specifically, the representation may comprise a plurality of nodes of a graph representing the respective road users 30 and a plurality of edges of the graph specifying the relationships of the road users 30 to each other. Based on the representation, a future development of the traffic scene can then be predicted according to a third method step 103. The prediction 103 may be performed taking into account the current and past states of the road users 30, wherein a behavior of all represented road users 30 is predicted based on the provided representation, in particular a single representation, in particular a single GNN. The result of the prediction can then be provided according to a fourth method step 104. The result can also be used to plan the behavior of an at least semi-autonomous robot 60 and in particular a vehicle 60 based on the provided result of the prediction 103.

FIG. 1 also shows a training method 300 for training a machine learning model 50 to evaluate a traffic scene with several road users 30. The machine learning model 50 can be designed as an artificial neural network, preferably a GNN. According to a first training step 301, training data may be provided, wherein the training data specifies road users 30 in a traffic scene and associated features, wherein the features are at least partially based on, in particular differentiable, current and past states of the road users 30. According to a second training step 302, a machine learning model 50 may be trained for predicting 103 a future development of the traffic scene, wherein the road users 30 are represented by nodes of a graph and their relationships in the traffic scene are represented by edges of the graph, wherein the relationships are specified based on the features, wherein an infrastructure of the traffic scene is represented by a parameterized representation. Here, the prediction 103 may be trained by a differentiable simulation taking into account the current and past states of the road users 30 to predict a behavior of all represented road users 30 based on the provided representation.

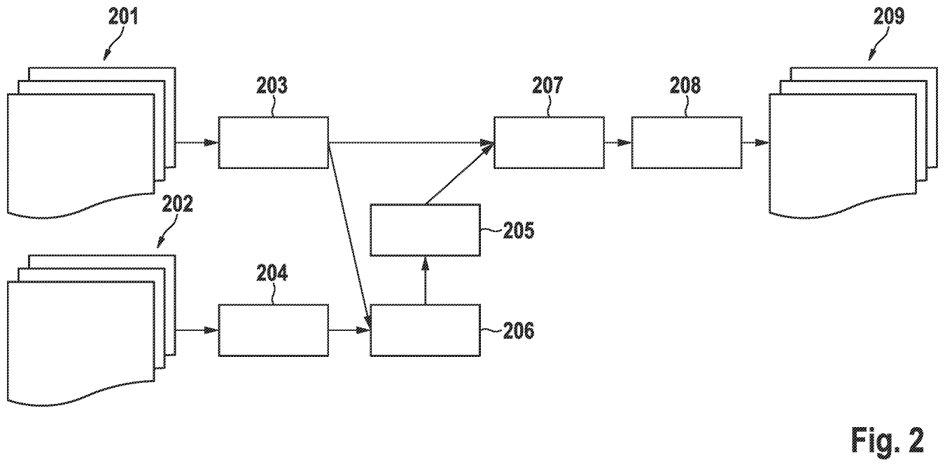

FIG. 2 shows the model 50 shown in FIG. 1 with further details according to exemplary embodiments of the disclosure. The model 50 can be designed as a graph neural network (GNN), in particular in the form of an agent-centered GNN. The GNN can receive agent information 201 as input data 40 and model the relationships between the agents using node and edge features. The road users 30 in the traffic scene are referred to as the agents (see FIG. 1).

The agent information 201 may comprise node features, which may be agent-centric. This means that the node features can be specified from the agent's point of view (e.g., with regard to relative speed and the like). The node features can comprise differentiable and semantic features that are either constant, e.g., agent type or agent dimensions, or calculated in a differentiable manner from a history of states, such as velocity, acceleration, yaw rate or the like. These features can be designed in such a way that they are invariant in terms of rotation and translation with respect to the coordinates, especially global coordinates. The node features can also comprise a differentiable embedding of the map topology. Possible embedding of the topology in various embodiments of the disclosure are described below.

Furthermore, edge information 202 may be provided as input data 40 of the GNN, which comprises edge features. The edge features can model the spatial and state-based relationship between two agents and can thus be described as “agent-relative”. Similar to the node features, the edge features can also be calculated in a differentiable manner from the state progressions of the agents, e.g., as a difference in position, difference in speed, difference in acceleration, difference in course or similar. These features can in turn be selected in such a way that they are invariant in terms of rotation and translation in relation to the coordinates, particularly global coordinates.

FIG. 2 also shows that an edge model 206 and a node model 207 can be provided on the basis of an output of the embeddings 203, 204. Furthermore, the output of the edge model 206 can be processed by an edge aggregation 205.

In the following, several examples of GNNs according to embodiments of the disclosure based on the model 50 shown in FIG. 2 are further described. These examples differ in particular in the method used to determine the rotation-and translation-invariant topology.

According to an exemplary embodiment of the disclosure, the differentiable and translation and rotation invariant embedding of the topology can be obtained in the following way: First, an image of the entire topology relevant to the given scenario is rendered from a bird's eye view, similar to that described in “Bansal et al., ChauffeurNet: Learning to Drive by Imitating the Best and Synthesizing the Worst. In: arXiv: 1812.03079v1 [cs.RO] 7 Dec. 2018”. This picture can be static for the entire scenario and therefore does not have to be differentiable.

Second, a section of this image aligned with the agent's current position and orientation can be created using spatial transformers, see e.g., “Jaderberg et al., Spatial Transformer Networks. In: NeurIPS 2015”. This section can be differentiable in terms of the position and orientation of the agent. Due to the alignment with the position and orientation of the agent, this section can also be invariant to the coordinate system, especially the global coordinate system. Finally, this section can be processed with any image-processing neural network, for example a ResNet as described in “Bergamini et al., SimNet: Learning Reactive Self-driving Simulations from Real-world Observations. In: arXiv: 2105.12332v1 [cs.RO] 26 May 2021”. The output of this neural network then forms the desired topology embedding.

According to a further exemplary embodiment of the disclosure, the differentiable and translation- and rotation-invariant embedding of the topology can be obtained in the following way: First, polylines expressing the topology elements can be obtained in a similar way as in “Gao et al., VectorNet: Encoding HD Maps and Agent Dynamics from Vectorized Representation. In: arXiv: 2005.04259v1 [cs.CV] 8 May 2020” can be obtained. These polylines are static for the entire scenario and therefore do not need to be determined in a differentiable manner. Secondly, all or a selected subset of the relevant polylines can be aligned with the agent's current position. These lines can be differentiable according to the position and orientation of the agent. Due to the alignment with the position and orientation of the agent, these line segments are invariant to the coordinate system, especially the global coordinate system. Finally, each polyline point can be embedded, and each polyline can be processed as a subgraph similar to Gao et al. (2020). The polyline features can then be aggregated using any aggregation function. The result of this aggregation then forms the desired topology embedding. Other vectorized point representations can also be used instead of polylines.

In a further exemplary embodiment of the disclosure, the differentiable and translation and rotation invariant embedding of the topology can be obtained in the following manner: First, features can be obtained that represent atomic parts of the road network, e.g., lanelets (see Poggenhans et al., Lanelet2: A high-definition map framework for the future of automated driving. In: Conference: 2018 IEEE International Conference on Intelligent Transportation Systems (ITSC), 2018”, or more precisely their properties (position, type, . . .). These features are static for the entire scenario and therefore do not need to be determined in a differentiable manner. Secondly, all or a selected subset of the relevant (location-dependent) properties can be aligned with the agent's current position. These properties can be differentiable with respect to the position and orientation of the agent. Due to the alignment to the position and orientation of the agent, these features are invariant to the coordinate system, especially the global coordinate system. These features represent the node information that is entered into another Graph Neural Network. The edges represent the relationship (successor, predecessor, contiguous, in conflict, . . .) of these atomic elements. Based on this graph, a feature vector per agent-relative map can be computed (see FIG. 4c in “Battaglia et al., Relational inductive biases, deep learning, and graph networks. In: arXiv: 1806.01261v3 [cs.LG] 17 Oct. 2018”). The result of this aggregation then forms the desired topology embedding.

Using a graph represented by a set of node and edge features, especially differentiable ones, node and edge embeddings can be calculated with separate embedding models (e.g., neural networks). Based on these node and edge embeddings, a GNN model comprising a node model 207 and an edge model 206 can calculate the updated node embeddings. The updated node embeddings can be used as input to a decoder model that predicts the driving actions 209 (e.g., waypoints). The complete model 50, which includes the node and edge embedding layers 203, 204, the GNN layers, and the decoder layers 208, can then be trained end-to-end by behavioral cloning or in a differentiable simulation imitation learning environment.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for evaluating a traffic scene with several road users, comprising:
providing input data which results from recording of the traffic scene and which specifies the road users and associated features, wherein the features are based at least in part on current and past states of the road users;
providing a representation of the road users and their relationships to each other in the traffic scene and an infrastructure of the traffic scene, wherein the relationships are specified based on the features, wherein the infrastructure is represented by a parameterized representation, wherein the representation comprises a plurality of nodes of a graph representing the respective road users, and wherein the representation comprises a plurality of edges of the graph explicitly specifying the relationships of the road users to each other;
predicting a future development of the traffic scene, wherein the prediction is performed taking into account the current and past states of the road users, and wherein a behavior of all represented road users is predicted on the basis of the provided representation; and
providing a result of the prediction.

2. The method according to claim 1, wherein:
the features are semantic features which are calculated from the current and past states, and
the features are invariant in terms of rotation and translation with respect to coordinates of the traffic scene.

3. The method according to claim 1, wherein:
the prediction is performed by way of a machine learning model which is implemented as a graph neural network which has the nodes and edges, and
the nodes represent the states of the respective road users.

4. The method according to claim 1, further comprising:
using a machine learning model to provide the representation, which comprises a first embedding based at least in part on the features and which comprises a second embedding specifying a topology at the traffic scene, the first and/or second embedding being invariant in terms of rotation and translation with respect to coordinates for the traffic scene.

5. The method according to claim 1, further comprising:
using a machine learning model to provide the representation, the features being based at least in part on the current and past states and being calculated in a differentiable manner from the state progressions of these states, and a first and/or second embedding of the machine learning model is implemented in a differentiable manner in order to train the machine learning model by way of a differentiable simulation.

6. The method according to claim 1, wherein:
the prediction is carried out on the basis of machine learning, the machine learning providing a simulation in which the machine learning is carried out on the basis of a difference between the current and past states of the road users, wherein the simulation is implemented as a differentiable simulation.

7. The method according to claim 1, wherein:
behavior planning of an at least partially autonomous robot is carried out on the basis of the provided result of the prediction, and
the robot is a part of the traffic scene.

8. A computer program comprising instructions that, when the computer program is executed by a computer, cause the computer to carry out the method according to claim 1.

9. A training method for training a machine learning model for evaluating a traffic scene with a plurality of road users, comprising:
providing training data, wherein the training data specifies road users in a traffic scene and associated features, wherein the features are based at least in part on current and past states of the road users; and
training a machine learning model for predicting a future development of the traffic scene, wherein the road users are represented by nodes of a graph and their relationships in the traffic scene to each other are represented by edges of the graph, wherein the relationships are specified based on the features, and wherein an infrastructure of the traffic scene is represented by a parameterized representation,
wherein the prediction is trained by a differentiable simulation taking into account the current and past states of the road users to predict a behavior of all represented road users based on the provided representation.

10. A device for data processing configured to carry out the method according to claim 1.

11. A computer-readable storage medium comprising instructions which, when executed by a computer, cause it to carry out the steps of the method according to claim 1.

12. The method according to claim 7, wherein the at least partially autonomous robot is a vehicle.
